(19) United States
(12) Patent Application Publication
(10) Pub. No.: US 2010/0264982 A1
(43) Pub. Date: Oct. 21, 2010

(54) ELECTRONIC CIRCUIT AND METHOD OF MASKING CURRENT REQUIREMENTS OF AN ELECTRONIC CIRCUIT

(75) Inventors: Michele Barcarolo, Gratkorn (AT); Harald Witschnig, Gratkorn (AT)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/808,008

(22) PCT Filed: Dec. 4, 2008
(86) PCT No.: PCT/IB08/55090

§ 371 Date: Jun. 14, 2010

(30) Foreign Application Priority Data
Dec. 13, 2007 (EP) 07123114.6

(51) Int. Cl. G05F 1/10

(52) U.S. Cl. 327/538

(57) ABSTRACT

A method of masking a current requirement of an electronic circuit (100) is provided, wherein the method comprises determining a current level required by the electronic circuit (100) and a corresponding point in time said current level is required by the electronic circuit (100), choosing a current level corresponding to a current level which is equal or higher than the determined current level, and switching a current level supplied to/consumed by the electronic circuit (100) to the chosen current level at a time instant deviating from the determined point in time.

### FIELD OF THE INVENTION

The invention relates to an electronic circuit, in particular, a secure device containing a micro controller or a hardwired logic (e.g. a state machine). The invention further relates to a method of masking current requirements of an electronic circuit. Furthermore, the invention relates to a program element. Finally, the invention relates to a computer-readable medium.

### BACKGROUND OF THE INVENTION

Many cryptographic devices are implemented using microprocessors and associated logic or using hardwired logic and (crypto)coprocessors on devices such as smart cards. It is often necessary to ensure that important data stored on smart cards, such as cryptographic keys and the like, is kept secure. A number of current/power analysis techniques have been published that facilitate obtaining of data from the smart card that would otherwise be securely encrypted in the course of normal input and output operations. In particular, analysis of the current/power consumption of the logic performing an encryption or decryption operation may be used to find out the round keys used in the encryption or decryption operation.

That is why every secure application as for instance smart cards, e-passport, e-ticketing, keyless access authorisation, and so-called secure-NFC, has to provide always improving ways to protect the sensible data of the application against hacking. To guarantee this protection, significant efforts are necessary, both in the hardware side and in the software one, to reach the needed system security level.

For each operative condition of the electronic circuit or chip of a smart card, a corresponding current/power consumption ideally fixed and constant (for that operative condition) is imposed, such to cover the actual consumption of the hardware modules involved in the mentioned operative condition. This is the so called current source principle, which is showing to the external world a constant current absorption for each operative condition.

In order to mask the current/power requirement of the electronic circuit, e.g. a smart card, and thus reducing the probability of a successful attempt to hack or crack the smart card, it is known to keep the current flowing into the smart card constant regardless which operations are performed by the electronic circuit or to perform current/power level variations on a random basis.

However, in reality, such “masking” is never perfect and can be attacked by Differential Power Analysis (DPA) attacks, which act through amplifying its imperfections, in the way to obtain important elements of the communications with the external world, as, for instance, the public keys.

### OBJECT AND SUMMARY OF THE INVENTION

One object of the invention is to provide an alternative electronic circuit and an alternative method of masking current requirements of an electronic circuit, which method has enhanced capability of masking the current requirement thus leading to an enhanced hardware security level of a system against Differential Power Analysis (DPA) attacks.

In order to achieve the object defined above, an electronic circuit, a method of masking current requirements of an electronic circuit, a program element, and a computer-readable medium, according to the independent claims are provided.

According to an exemplary aspect of the invention, a method of masking a current requirement of an electronic circuit is provided, wherein the method comprises the steps of determining a current level required by the electronic circuit for its correct operation and a corresponding point in time when said current level is required by the electronic circuit, choosing a current level which is equal or higher than the determined current level, and switching a current level supplied to/consumed by the electronic circuit to the chosen current level at a time instant deviating from the determined point in time.

According to another exemplary aspect of the invention, an electronic circuit is provided, which comprises a determination unit adapted to determine a current level required by the electronic circuit for its correct operation and a corresponding point in time when said current level is required by the electronic circuit, a choosing unit adapted to choose a current level which is equal or higher than the determined current level, and a switching unit adapted to switch a current level supplied to/consumed by the electronic circuit to the chosen current level at a time instant deviating from the determined point in time. In particular, the electronic circuit may further comprise a random generator adapted to generate a random time offset value, wherein the random time offset may be utilized by the switching unit in order to determine the time instant.

According to another exemplary aspect of the invention, a program element is provided, which is adapted to control or carry out a method according to an exemplary aspect of the invention when being executed by a processor.

According to another exemplary aspect of the invention a computer-readable medium, in which a computer program is stored, which program is adapted to control or carry out a method according to an exemplary aspect of the invention when being executed by a processor.

In this application the term “electronic circuit” may particularly denote any kind of electronic circuit, e.g. integrated circuit or chip, which may be implemented in a secure device implementing for example a micro controller, coprocessor and memory, both in contact and contactless applications. Such a secure device may be a smart card possibly having a double or triple interface, a so-called secure NFC, or an electronic passport or e-passport. In particular, the electronic circuit may comprise a micro controller or CPU and a coprocessor.

Thus, according to this exemplary aspect, a method is provided, which switches the current levels at time instants different to the actual point in times, at which the new current or current level is necessary for an electronic circuit implemented into a smart card. Thus, the real point in time of an activation of an electronic circuit (e.g. a crypto coprocessor) of the smart card is masked so that the probability of a DPA attack is reduced. In particular, the difference between the points in time a certain current level is required and the time instant the current level is actually switched may be variable and may be set randomly for each switching. Thus, the disadvantages of the prior art, i.e. typically constant time between electronic circuit's (or module's) request to start to operate and the corresponding update of the value of a current source port, together with the consequent concession to the module to start to operate may be omitted. This constant time represents a potential weak point of prior art systems, because it facilitates the trigger of the monitoring action during a potential DPA attack.

The current level can be switched by various means, e.g. a current source able to switch different current levels wherein the superfluous current or power, which currently is not being used for a correct operation of the electric circuit, is fed to a resistor, which transforms said superfluous power to heat. However, one can imagine that the electric circuit is powered by a constant voltage source or a constant current source. In this case, superfluous heat can be “wasted” by a resistor, whose resistance can be set. In this context, one will easy perceive that instead of a resistor a transistor can be used, which can be implemented in an integrated circuit easier.

The method according to an exemplary aspect of the invention may be realized by a computer program, that is, by software, or by using one or more special electronic optimization circuits, that is in hardware, or in hybrid form, that is by means of software components and hardware components.

In an advantageous embodiment, an actual current requirement of an electronic circuit or module is masked by introducing a variable and/or random time interval between the point in time a certain current requirement is given and the time instant the current source switches to the current level corresponding to that certain current requirement. Thus, the actual point in time the electronic circuit, e.g. a crypto coprocessor, starts to operate is masked so that a possible DPA attack is hampered. It should be noted that of course in some switching actions the time deviation may be zero, i.e. it may also be possible that the switching is performed at the point in time the current level supplied to/consumed by the electronic circuit has to be changed, however according to an exemplary embodiment of the method it is possible that the time instant is different to that point in time. Additionally to the masking of the switching time, the current level, which is supplied may be chosen randomly. However, it should be noted that the chosen current level should ensure that the electronic circuit or the whole secure device, e.g. smart card, is operable.

Next, further exemplary embodiments of the method of masking a current requirement are described. However, these embodiments also apply to the electronic circuit, the program element and the computer-readable medium.

According to an exemplary embodiment, the method further comprises the step of supplying a current corresponding to the chosen current level to the electronic circuit. In particular, the current may be supplied to the electronic circuit by a current source adapted to switch between different current levels, e.g. a high current level and a low current level. When talking about smart cards, this current source can be located on a smart card, which comprises the inventive electronic circuit, or in the terminal, in which the smart card is inserted. However, the location of the current source is not limited to smart cards or terminals.

According to another exemplary embodiment of the method, the time deviation is randomly chosen. In particular, a random number generator (RNG) may be utilized to choose or to determine the time deviation. The use of an RNG may ensure that the time deviation or the time offset and thus the switching time instant is truly randomly chosen, that means there is no constant time between the point in time the electronic circuit requests the current level and the actual switching time instant is given. Thus, the probability of a successfully DPA attack is decreased. For example, the time offset may have a positive value, a negative value or may be zero and the time instant of switching may be determined by adding the point of time said current level is required by the electronic circuit and the offset time. In particular, the time instant the switching is performed may be earlier in time than the determined point in time in case the current level or current level is switched to a higher level, e.g. from the low level to the high level, while the time instant the switching is performed may be later in time than the determined point in time in case the current or current level is switched to a lower level, e.g. from the high level to the low level. As already mentioned, it is possible that a time deviation/offset of zero is chosen by chance. However, contrary to known method a possible hacker may not rely on the fact that no time offset is present so that a possible DPA attack is hampered.

According to an exemplary embodiment of the method, the chosen current level is randomly chosen. By determining a current level or current offset, which is randomly chosen, an additional masking of the current requirement is enabled. For example, for every switching of the current level a different current offset may be chosen so that a successful DPA attack may become less probable. Such a current offset may be particularly advantageous in connection with contact applications, e.g. in applications a battery or a power supply is powering the electronic circuit, e.g. a set top box or a mobile phone.

Finally, the method is advantageous if power levels are used instead of current levels. In particular if the supply voltage of the electric circuit has fluctuations, it can be useful to determine, choose, and switch power levels instead of current levels. In this way the power consumption of an inventive electric circuit can be masked. Normally, power is measured via current and voltage. However, one should also note that power can be measured just by use of a voltage drop of a resistor (power U divided by R). In this context, the current is implicitly measured (by U divided by R).

The aspects and exemplary embodiments defined above and further aspects of the invention are apparent from the example of embodiment to be described hereinafter and are explained with reference to these examples of embodiment. It should be noted that features described in connection with one exemplary embodiment or exemplary aspect may be combined with other exemplary embodiments and other exemplary aspects.

### BRIEF DESCRIPTION OF THE DRAWINGS

The invention will be described in more detail hereinafter with reference to examples of embodiment but to which the invention is not limited.

FIG. 1 schematically illustrates a smart card, which may be adapted to perform a method according to an exemplary embodiment.

FIG. 2 schematically illustrates timing diagrams of current levels.

### DESCRIPTION OF EMBODIMENTS

The illustration in the drawing is schematically. In different drawings, similar or identical elements are provided with similar or identical reference signs.

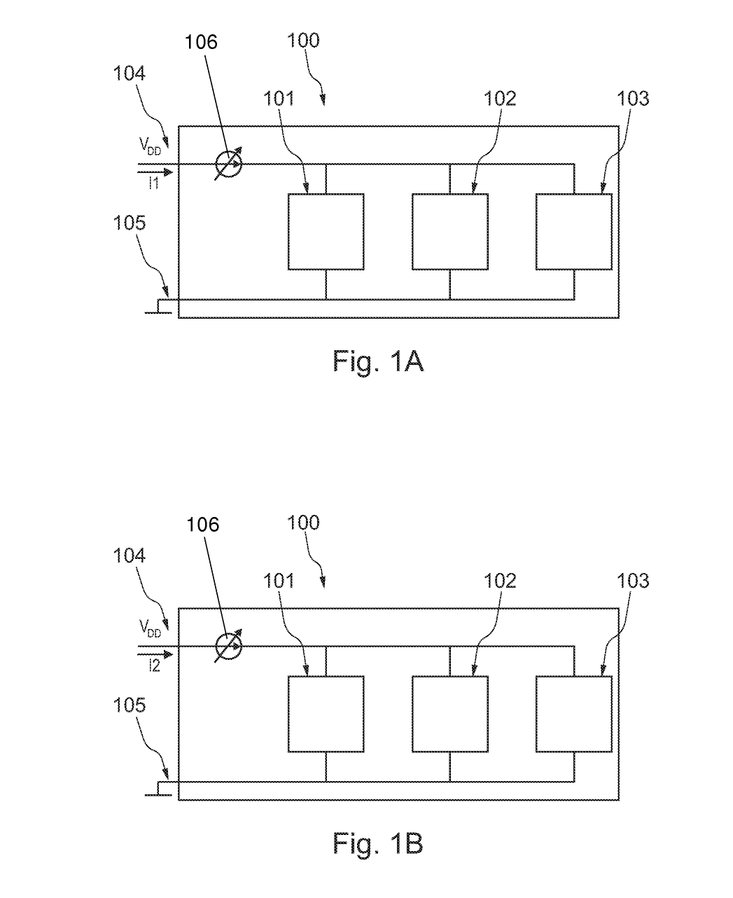

FIG. 1 schematically shows a smart card, an IC, or an electronic circuit 100 comprising a CPU 101, a crypto coprocessor 102, a non-volatile memory 103, and a current source 106. Furthermore, a current input path 104 and an output path 105 are depicted schematically. In the operation state shown in FIG. 1A only the CPU 101 is active and the crypto coprocessor 102 is inactive, while in the operation state shown FIG. 1B also the crypto coprocessor 102 is active. The CPU may comprise or may form a determination unit adapted to determine a current level required by the electronic circuit and a corresponding point in time said current level is required by the electronic circuit, a choosing unit adapted to choose a current level corresponding to a current level which is equal or higher than the required current level, and a switching unit. These units may be formed by software implemented in the CPU, stored in the non-volatile memory, hardwired circuits, or a hybrid.

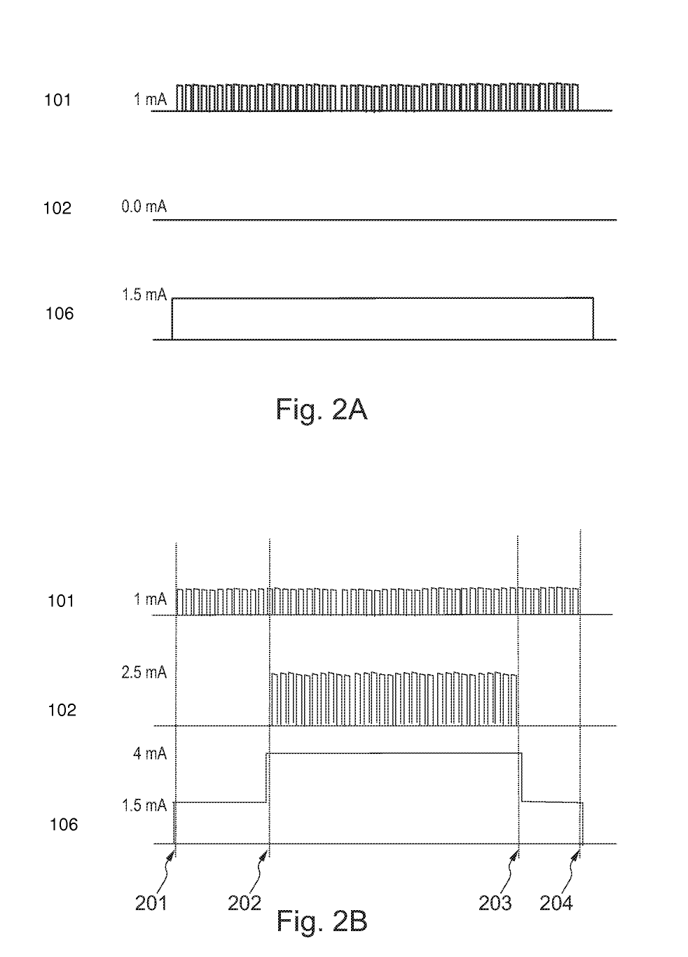

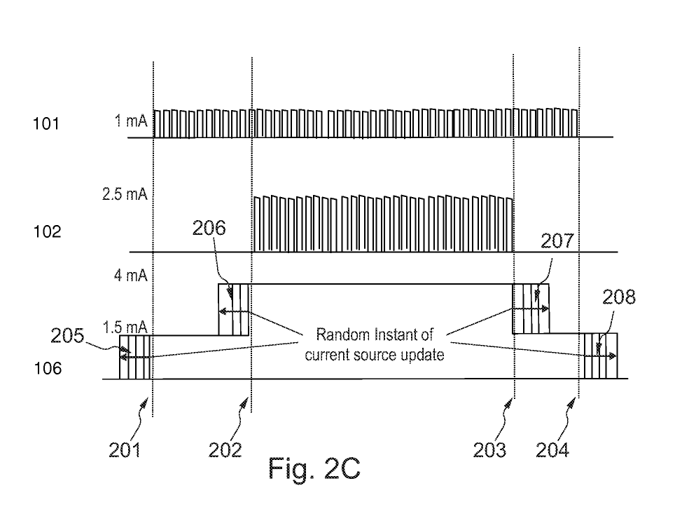

FIG. 2 schematically shows timing diagrams corresponding to different methods and operation states. FIG. 2A shows a timing diagram corresponding to the operation state shown in FIG. 1A. The timing diagram for the operation state in FIG. 2A shows current masking according to a known method. FIG. 2A shows the required current over time of the CPU 101 in the first row, the current required by the crypto coprocessor 102 in the second row, and the current supplied by the current source 106 via the current input path 104 in the third row. Because only the CPU 101 is active, only the CPU 101 requires a peak current of 1 mA, for example. To have a safety margin, the current source 106 is set to 1.5 mA. It should be noted that in reality there are components, which consume the energy, which is not needed by the CPU 101, thus keeping the current absorbed from the supply pads ideally constant at 1.5 mA. These components (e.g. a resistor or a transistor for “wasting” superfluous energy and switched in parallel to the CPU 101) are not shown in FIG. 1 for sake of brevity. Thus, in the operation state shown in FIGS. 1A and 2A a hacker ideally only sees a constant current of 1.5 mA at the contacts or terminals.

FIG. 2B shows a timing diagram corresponding to the operation state shown in FIG. 1B of a known smart card using a known method, i.e. the required current over time of the CPU 101 in the first row, the current required by the crypto coprocessor 102 in the second row, and the current supplied by the current source 106 via the current input path 104 in the third row. Because both the CPU 101 and the crypto coprocessor 102 are active, the crypto coprocessor 102 requires another 2.5 mA of peak current, for example. To have a safety margin, the current source 106 is set to 4.0 mA. In particular, such a known smart card requires a rapid update from current I1 of 1.5 mA to current I2 of 4.0 mA in a very short time in the given example. Usually, said time is around 1 ns or less within a typically fixed temporal window, e.g. between 0.5 and 1.5 clock cycles, of a current source register. This update and the corresponding switching happens whenever a coprocessor or a memory module requests the CPU (or in easier cases the state machine) to start operation. For illustrative purpose, some specific points in time are indicated in FIG. 2B. The point in time the smart card 100 goes active, i.e. the point in time the CPU 101 is activated, is indicated by the dashed lines 201. The point in time the coprocessor goes active is indicated by dashed line 202, while the dashed line 203 indicates the point in time, at which the coprocessor becomes inactive again and the dashed line 204 indicates the point in time, at which the smart card 100 becomes inactive again.

FIG. 2C shows a timing diagram corresponding to the operation state shown in FIG. 1B of a smart card implementing an inventive method according to an exemplary embodiment. The timing diagram shown in FIG. 2C is similar to the timing diagram shown in FIG. 2B. However, the switching is done at different points in time. In particular, an additional time interval is introduced for determining the time instants when the current source switches to another current level. In an advantageous embodiment, said time intervals are limited so that there are time spans 205, 206, 207, and 208, during which the random switching can be done.

Time span 205 indicates a range for time instants when the current source 106 starts to supply a current adequate to supply the CPU 101 and thus to activate the smart card 100. FIG. 2c clearly shows that the time instant is different to the point in time when the CPU 101 actually goes active as indicated by the dashed line 201. That means, that the activation of the CPU 101 does not necessarily coincide with the switching of the current source 106. Time span 206 indicates a range for time instants when the current source 106 starts to supply a current adequate to supply the CPU 101 and the coprocessor 102. Again, the time instant is different to the point in time the coprocessor 102 actually goes active as indicated by the dashed line 202. Time span 207 indicates a range for time instants when the current source 106 starts to supply a current adequate to supply only the CPU 101, since the coprocessor 102 becomes inactive again. This time instant is different to the point in time the coprocessor 102 actually goes inactive as indicated by the dashed line 203. Finally, time span 208 indicates a range for time instants when the current source 106 stops to supply a current to the smart card 100, wherein the time instant is different to the point in time the smart card 100 actually becomes inactive as indicated by the dashed line 204.

It should be noted that the switching times may be randomly chosen. However, it should be ensured that required current levels are always supplied to the smart card, i.e. that the supplied current levels at least matches the current requirements of all components of the smart cards, which are necessary at a specific point in time (for instance by choosing a constant value of current covering the peaks of consumption with a reasonable safety margin as described hereinbefore).

Finally, it should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprise” and its conjugations do not exclude the presence of elements or steps other than those listed in any claim or the specification as a whole. The singular reference of an element does not exclude the plural reference of such elements and vice-versa. In a device claim enumerating several means, several of these means may be embodied by one and the same item. The mere fact that certain measures are recited in mutually different dependent claims does not indicate that a combination of these measures cannot be used to advantage.

1. A method of masking a current requirement of an electronic circuit, the method comprising the steps of:
determining a current level required by the electronic circuit for its correct operation and a corresponding point in time when said current level is required by the electronic circuit;
choosing a current level which is equal or higher than the determined current level, and
switching a current level supplied to/consumed by the electronic circuit to the chosen current level at a time instant deviating from the determined point in time.

2. The method according to claim 1, further comprising the step of supplying a current corresponding to the chosen current level to the electronic circuit.

3. The method according to claim 1, wherein said time deviation is randomly chosen.

4. The method according to claim 1, wherein said chosen current level is randomly chosen.

5. The method according to claim 1, wherein power levels are used instead of current levels.

6. An electronic circuit comprising:
a determination unit adapted to determine a current level required by the electronic circuit for its correct operation and a corresponding point in time when said level of current is required by the electronic circuit;
a choosing unit adapted to choose a current level which is equal or higher than the determined current level, and
a switching unit adapted to switch a current level supplied to/consumed by the electronic circuit to the chosen current level at a time instant deviating from the determined point in time.

7. The electronic circuit according to claim 6, further comprising a random generator adapted to generate a random time offset value.

8. A program element, which is adapted to control or carry out a method according to claim 1 when being executed by a processor.

9. A computer-readable medium, in which a computer program is stored, which is adapted to control or carry out a method according to claim 1 when being executed by a processor.
